(19) United States
(12) Patent Application Publication
(10) Pub. No.: US 2026/0039774 A1
(43) Pub. Date: Feb. 5, 2026

(54) SYSTEM AND METHOD FOR PROVIDING DASHCAM FOOTAGE

(71) Applicant: Seung Hwan LEE, Seoul (KR)

(72) Inventor: Seung Hwan LEE, Seoul (KR)

(21) Appl. No.: 19/279,720

(22) Filed: Jul. 24, 2025

(30) Foreign Application Priority Data
Jul. 31, 2024 (KR) 10-2024-0101500

(51) Int. Cl. H04N 7/18; G06Q 20/12; G06V 10/74; G06V 20/56; H04L 9/40

(52) U.S. Cl. CPC H04N 7/185; G06Q 20/123; G06V 10/761; G06V 20/56; H04L 63/0428

(57) ABSTRACT

A system for providing dashcam footage includes a provider terminal, a consumer terminal, and a video brokerage server, and is characterized by: a provider terminal configured to transmit at least one of metadata and dashcam footage to the video brokerage server; a consumer terminal configured to connect to the video brokerage server and input request information including the time, location, and spot footage of an area of interest for the desired footage; and a video brokerage server configured to derive search metadata of searchable footage within a predefined search range based on the request information from the metadata, receive the corresponding searchable footage from the provider terminal, derive similar footage by comparing it with the spot footage using an artificial intelligence-based visual similarity model, apply de-identification processing, and transmit the de-identified similar footage to the consumer terminal for provision.

### CROSS-REFERENCE TO RELATED APPLICATION

This application claims priority to Korean Patent Application No. 10-2024-0101500 filed on Jul. 31, 2024, and all the benefits accruing therefrom under 35 U.S.C. § 119, the contents of which are incorporated herein by reference in their entirety.

### BACKGROUND OF THE DISCLOSURE

### Field of the Disclosure

The present disclosure relates to a system and method for providing video footage. In particular, the present disclosure relates to a system and method for providing dashcam footage that enables fast and accurate retrieval and provision of dashcam footage similar to a desired video requested by a consumer, by performing de-identification processing.

### Description of the Related Art

In general, a CCTV-linked DVR (Digital Video Recorder) system may be cited as a video information collection device for crime prevention and evidence acquisition. A DVR system linked with CCTV is a device that can continuously monitor and record a limited area, and it manages video information that may be used as evidence in case of a crime or incident.

However, such a system has spatial limitations in that it cannot obtain video information from areas where CCTV is not installed or from blind spots beyond the coverage of CCTV, since the system continuously monitors a limited space.

As another means of securing evidence, vehicle DVR systems have been developed to more objectively and clearly determine the cause and responsibility in the event of a traffic accident.

Unlike CCTV-linked DVR systems, vehicle DVR systems are not spatially restricted. However, the data collected by the vehicle DVR systems is difficult to use as evidence for third parties. This is because vehicles are constantly moving, and even if a particular vehicle captures video information related to a specific event at a specific time and place, it is difficult for the user in need of that footage to identify the vehicle that possesses the footage.

Furthermore, even when a consumer of video footage attempts to find footage from a vehicle that passed through a specific area at the time of an incident, it is extremely difficult and time-consuming to verify whether the footage was captured at the exact location and angle of view required, and whether it is truly relevant to the user's needs.

In addition, video footage collected through such vehicle DVR systems or dashcam (black box) systems often contains personal information protected under privacy laws, such as the Personal Information Protection Act, making it legally difficult to utilize the footage due to regulatory constraints.

### Related Patent Document

Korean Patent Publication No. 10-2008-0000823 (Publication Date: Jan. 23, 2008)
Korean Patent Publication No. 10-2011-0078421 (Publication Date: Jul. 7, 2011)

### SUMMARY OF THE DISCLOSURE

The purpose of the present disclosure, which aims to solve the aforementioned conventional problems, is to provide a system and method for providing dashcam footage, which enables rapid search of footage based on time, location, and region of interest, by the request of a consumer, thereby allowing the consumer to efficiently and quickly find the desired footage.

In addition, the purpose of the present disclosure is to provide a system and method for providing dashcam footage, which can accurately and rapidly derive footage similar to the dashcam footage requested by the consumer, thereby being highly effective in finding footage with a viewing angle very similar to the one desired by the consumer.

In addition, the purpose of the present disclosure is to provide a system and method for providing dashcam footage, which can effectively perform de-identification processing on personal information within the footage (e.g., faces, vehicle license plates), thereby enhancing the usability of the footage while ensuring the protection of personal information.

In order to achieve the purpose, an aspect of the present disclosure provides a system for providing dashcam footage comprising a provider terminal, a consumer terminal, and a video brokerage server,
wherein the provider terminal may be configured to transmit at least one of metadata of dashcam footage or the dashcam footage to a video brokerage server:
wherein the consumer terminal may be configured to access the video brokerage server and input request information for desired dashcam footage, the request information including time, location, and a spot image of a region of interest; and wherein the video brokerage server may be configured to:
derive, from the metadata, search metadata of search footage within a preset search range based on the request information;
receive the search footage corresponding to the derived search metadata from the provider terminal;
derive similar footage using an artificial intelligence-based image similarity model based on the spot image;
perform de-identification processing on the similar footage; and
transmit the de-identified similar footage to the consumer terminal, for providing the de-identified similar footage.

In some exemplary embodiments, the provider terminal may be a terminal device connected via wired or wireless communication to a dashcam device mounted on a mobility and configured to receive the dashcam footage, the terminal device being at least one selected from the group consisting of a navigation terminal, a vehicle terminal, and a mobile device.

In some exemplary embodiments, the consumer terminal may comprise:
a registration unit configured to access the video brokerage server and perform user registration;
a video request unit configured to input request information including time, location, and a spot image of a region of interest to request desired dashcam footage; and
an output unit configured to receive the de-identified similar footage from the video brokerage server and output the de-identified similar footage.

In some exemplary embodiments, the video brokerage server may comprise:
a database configured to store and manage the dashcam footage received from the provider terminal;
a search image retrieval unit configured to derive search metadata of search footage within a preset search range from the metadata based on the request information, request the search footage corresponding to the derived search metadata from the provider terminal, and receive the search footage from the provider terminal;
a similar image derivation unit configured to derive footage having a similarity equal to or higher than a preset threshold by comparing the derived search footage with the spot image included in the request information using the artificial intelligence-based image similarity model;
a de-identification processing unit configured to detect a personally identifiable object in the similar footage derived by the similar image derivation unit and perform de-identification processing on the detected personally identifiable object; and
a video provision unit configured to transmit the de-identified similar footage to the consumer terminal.

In some exemplary embodiments, the de-identification processing unit may comprise:
an object detection module configured to detect and identify a personally identifiable object in the similar footage using an object detection artificial intelligence model based on the request information;
a de-identification processing module configured to perform de-identification processing on the detected personally identifiable object, the de-identification processing including at least one selected from the group consisting of mosaic processing and blur processing; and
a de-identification level setting module configured to reset a level of de-identification processing based on a request from a provider or administrator.

In some exemplary embodiments, the video provision unit may comprise:
a transaction settlement unit configured to process transaction settlement when the consumer terminal confirms a portion of the de-identified similar footage processed by the de-identification processing unit and decides to purchase the de-identified similar footage; and
a video transmission unit configured to transmit the de-identified similar footage to the consumer terminal when the transaction settlement by the transaction settlement unit is completed.

In addition, in order to achieve the purpose, another aspect of the present disclosure provides a method for providing dashcam footage, comprising the steps of:
(a) collecting, by a provider terminal, metadata of dashcam footage and transmitting the collected metadata to a video brokerage server;
(b) receiving and storing, by the video brokerage server, the metadata from the provider terminal for management;
(c) requesting, by a consumer terminal, dashcam footage by accessing the video brokerage server and inputting request information including time, location, and a spot image of a region of interest; and
(d) deriving, by the video brokerage server, search metadata of search footage within a preset search range from the metadata based on the request information: receiving the search footage corresponding to the derived search metadata from the provider terminal: deriving similar footage using an artificial intelligence-based image similarity model based on the spot image: performing de-identification processing on the similar footage; and transmitting the de-identified similar footage to the consumer terminal.

In some exemplary embodiments, the step (c) may comprise:
(c1) accessing, by a registration unit, the video brokerage server and performing user registration; and
(c2) requesting, by a video request unit, dashcam footage through request information input by a consumer, the request information including time, location, and a spot image of a region of interest of the dashcam footage.

In some exemplary embodiments, the step (d) may comprise:
(d1) deriving, by a search image retrieval unit, search metadata of search footage within a preset search range from the metadata based on the request information;
(d2) transmitting, by the search image retrieval unit, the derived search metadata to the provider terminal and receiving the search footage corresponding to the derived search metadata from the provider terminal;
(d3) deriving, by a similar image derivation unit, similar footage having a similarity equal to or higher than a preset threshold by comparing the received search footage with the spot image included in the request information using the artificial intelligence-based image similarity model;
(d4) detecting, by a de-identification processing unit, a personally identifiable object in the similar footage using an artificial intelligence-based object detection model, and performing de-identification processing on the detected personally identifiable object;
(d5) processing, by a transaction settlement unit, transaction settlement when the consumer terminal confirms a portion of the de-identified similar footage processed by the de-identification processing unit and decides to purchase the similar footage; and
(d6) transmitting, by a transmission unit, the de-identified similar footage to the consumer terminal when the transaction settlement by the transaction settlement unit is completed.

In addition, in order to achieve the purpose, still another aspect of the present disclosure provides a computer program stored on a medium for executing the method for providing dashcam footage.

Specific details of other exemplary embodiments are included in “Details for carrying out the invention” and accompanying “drawings”.

Advantages and/or features of the present disclosure, and a method for achieving the advantages and/or features will become obvious with reference to various exemplary embodiments to be described below in detail together with the accompanying drawings.

However, the present disclosure is not limited only to a configuration of each exemplary embodiment disclosed below, but may also be implemented in various different forms. The respective exemplary embodiments disclosed in this specification are provided only to complete disclosure of the present disclosure and to fully provide those skilled in the art to which the present disclosure pertains with the category of the present disclosure, and the present disclosure will be defined only by the scope of each claim of the claims.

According to the present disclosure, by utilizing GIS (Geographic Information System) and computer vision technologies, there are provided system and method for providing dashcam footage, which enable rapid retrieval of footage based on the time, location, and region of interest requested by a consumer, thereby allowing the consumer to efficiently and quickly find the desired footage.

In addition, according to the present disclosure, by applying a deep learning model, a system and method are provided that can accurately derive footage similar to a requested spot image, thereby enabling the consumer to effectively find footage having a viewpoint highly similar to the desired one.

Furthermore, the present disclosure provides a dashcam footage providing system and method capable of effectively performing de-identification processing on personal information (e.g., faces, license plates) within the footage using a deep learning-based object detection model and mosaic processing technology, thereby ensuring privacy protection while enhancing footage usability.

Moreover, according to the present disclosure, by including a module capable of adjusting the level of de-identification processing, appropriate de-identification can be applied based on the situation, providing flexibility to accommodate various requirements.

The present disclosure also provides enhanced data security by encrypting the de-identified footage before transmission and prevents data loss through a backup module that securely stores data.

In addition, the present disclosure provides an intuitive interface through which a consumer terminal can easily input request information and receive de-identified footage, thereby improving user experience and enhancing accessibility to the system.

Further, the present disclosure provides a system and method capable of enabling consumers to purchase and settle payments for the desired footage, thereby offering an opportunity for providers to generate additional revenue and enhancing the economic value of dashcam footage.

Moreover, the present disclosure allows the consumer to preview a portion of the de-identified footage before making a purchase decision, thereby enabling evaluation on the quality and relevance of the footage prior to purchase.

Furthermore, the present disclosure provides system flexibility and scalability by enabling dashcam footage to be collected and provided through various devices such as navigation terminals, vehicle terminals, and mobile devices. The system and method can also be applied in various fields such as traffic accident analysis, road condition monitoring, insurance claim processing, and urban planning.

Finally, the present disclosure ensures system reliability and stability through DBMS (Database Management System) that efficiently manage large volumes of data and high-speed storage devices, and enables real-time collection, storage, and provision of dashcam footage, allowing for prompt responses based on up-to-date information.

### BRIEF DESCRIPTION OF THE DRAWINGS

FIG. 1 is a block diagram illustrating the configuration of a system for providing dashcam footage according to an exemplary embodiment of the present disclosure.

FIG. 2 is a flowchart illustrating a method for providing dashcam footage according to an exemplary embodiment of the present disclosure.

FIG. 3 is a diagram illustrating a detailed process of providing footage using the system for providing dashcam footage according to an embodiment of the present disclosure.

### DETAILED DESCRIPTION OF THE DISCLOSURE

Before describing the present disclosure in detail, the terms or words used in this specification should not be construed as being unconditionally limited to their ordinary or dictionary meanings, and in order for the inventor of the present disclosure to describe his/her disclosure in the best way, concepts of various terms may be appropriately defined and used, and furthermore, the terms or words should be construed as means and concepts which are consistent with a technical idea of the present disclosure.

That is, the terms used in this specification are only used to describe preferred embodiments of the present disclosure, and are not used for the purpose of specifically limiting the contents of the present disclosure, and it should be noted that the terms are defined by considering various possibilities of the present disclosure.

Further, in this specification, it should be understood that, unless the context clearly indicates otherwise, the expression in the singular may include a plurality of expressions, and similarly, even if it is expressed in plural, it should be understood that the meaning of the singular may be included.

In the case where it is stated throughout this specification that a component “includes” another component, it does not exclude any other component, but may further include any other component unless otherwise indicated.

Furthermore, it should be noted that when it is described that a component “exists in or is connected to” another component, this component may be directly connected or installed in contact with another component, and in inspect to a case where both components are installed spaced apart from each other by a predetermined distance, a third component or means for fixing or connecting the corresponding component to the other component may exist, and the description of the third component or means may be omitted.

On the contrary, when it is described that a component is “directly connected to” or “directly accesses” to another component, it should be understood that the third element or means does not exist.

Similarly, it should be construed that other expressions describing the relationship of the components, that is, expressions such as “between” and “directly between” or “adjacent to” and “directly adjacent to” also have the same purpose.

In addition, it should be noted that if terms such as “one side surface”, “other side surface”, “one side”, “other side”, “first”, “second”, etc., are used in this specification, the terms are used to clearly distinguish one component from the other component and a meaning of the corresponding component is not limited used by the terms.

Further, in this specification, if terms related to locations such as “upper”, “lower”, “left”, “right”, etc., are used, it should be understood that the terms indicate a relative location in the drawing with respect to the corresponding component and unless an absolute location is specified for their locations, these location-related terms should not be construed as referring to the absolute location.

Further, in this specification, in specifying the reference numerals for each component of each drawing, the same component has the same reference number even if the component is indicated in different drawings, that is, the same reference number indicates the same component throughout the specification.

In the drawings attached to this specification, a size, a location, a coupling relationship, etc. of each component constituting the present disclosure may be described while being partially exaggerated, reduced, or omitted for sufficiently clearly delivering the spirit of the present disclosure, and thus the proportion or scale may not be exact.

Further, hereinafter, in describing the present disclosure, a detailed description of a configuration determined that may unnecessarily obscure the subject matter of the present disclosure, for example, a detailed description of a known technology including the prior art may be omitted.

Moreover, one or more “unit” and/or “module” described in this specification can be implemented via a non-transitory memory (not shown) and a processor (not shown). The memory is configured to store data concerning algorithms designed to control the operation of system components according to exemplary embodiments of the present disclosure, or software instructions that implement these algorithms. The processor is configured to perform the operations described below using the data stored in the memory. Here, the memory and the processor may be implemented as separate chips. Alternatively, the memory and the processor may be implemented as a single integrated chip. The processor may take the form of one or more processors.

Furthermore, in the specification of the present disclosure, terms such as “unit,” “device,” “module,” and “apparatus,” if used, refer to a unit capable of processing one or more functions or operations and should be understood to be implementable in hardware, software, or a combination of hardware and software.

As will be understood by those skilled in the art, the realization of all or some of the steps of the above exemplary embodiments may be accomplished through hardware, or may be accomplished by directing the relevant hardware through a computer program. The computer program may include instructions for executing some or all of the steps of the method, the computer program may be stored on a readable storage medium, and the storage medium may be any form of storage medium.

Hereinafter, exemplary embodiments of the present disclosure will be described in detail with reference to related drawings.

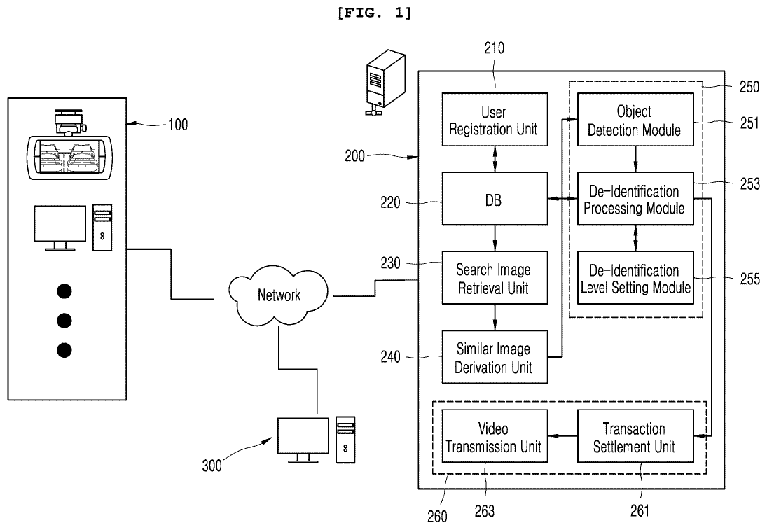

FIG. 1 is a block diagram illustrating the configuration of a system for providing dashcam footage according to an exemplary embodiment of the present disclosure.

As shown in FIG. 1, the system for providing dashcam footage according to an exemplary embodiment of the present disclosure may include a provider terminal 100, a consumer terminal 300, and a video brokerage server 200.

Here, the provider terminal 100 may be a terminal device configured to transmit at least one of metadata of dashcam footage or the dashcam footage to the video brokerage server 200.

That is, the provider terminal 100 may be a terminal device connected via wired or wireless communication to a dashcam device of a vehicle, and configured to receive metadata and footage of the dashcam and transmit them to an external device. The terminal device may be at least one selected from the group consisting of a navigation terminal, a vehicle terminal, and a mobile device.

In addition, the provider terminal 100 may also be the dashcam device itself. The dashcam device may include a storage device configured to store the recorded dashcam footage internally, and a communication device configured to transmit metadata of the stored dashcam footage in real time to the video brokerage server 200, and to transmit the corresponding dashcam footage to the video brokerage server 200 upon request of footage corresponding to the search metadata from the video brokerage server 200.

Herein, the dashcam footage may include footage captured not only by dashcams mounted on vehicles, but also by dashcams attached to other types of mobility such as motorcycles, bicycles, or helmets.

In addition, the metadata may include all information related to the dashcam footage, such as location, time, traveling direction, speed, and field of view.

By receiving, in real time or periodically, the metadata captured during the dashcam footage shooting from multiple registered provider terminals, as well as storing and managing the metadata in a database (DB), the video brokerage server can reduce the storage capacity and management cost of the DB, and also efficiently obtain primary information of the footage desired by the consumer through the metadata.

In addition, the provider terminal 100 may be a computing device connected to a dashcam device via a wired or wireless connection, wherein the wireless communication may employ wireless communication technologies such as Wi-Fi, Bluetooth, LTE/5G, TVWS (TV White Space), or LoRa (Long Range).

The consumer terminal 300 may be a terminal device configured to access the video brokerage server 200 and request dashcam footage by inputting request information including time, location, and a spot image of a region of interest.

The consumer terminal 300 may be connected to the video brokerage server 200 via a wired or wireless connection and may be a computing device capable of running a video provision platform service application, including, for example, a computer, laptop, smartphone, or tablet PC.

In particular, the consumer terminal 300 may comprise, although it is not illustrated in the drawings, as components of an application program installed on hardware, a user registration unit configured to access the video brokerage server 200 and perform user registration: a video request unit configured to request dashcam footage by inputting request information including time, location, and a spot image of a region of interest of the dashcam footage; and an output unit configured to receive and output de-identified footage from the video brokerage server 200.

As shown in FIG. 1, the video brokerage server 200 may be a server device configured to derive search metadata of search footage within a preset search range from the metadata described above based on request information from the consumer terminal 300, receive the search footage corresponding to the derived search metadata from the provider terminal 100, derive similar footage using an artificial intelligence-based image similarity model based on the spot image, perform de-identification processing on the similar footage, and transmit the de-identified similar footage to the consumer terminal.

In particular, the video brokerage server 200 may comprise a database (DB) 220, a search image retrieval unit 230, a similar image derivation unit 240, a de-identification processing unit 250, and a video provision unit 260.

The DB 220 may be a database device configured to store and manage the metadata and dashcam footage received from the provider terminal 100.

As a device for storing and managing the metadata and dashcam footage collected from the provider terminal 100, a database management system (DBMS) may be used to efficiently store, retrieve, and manage large-scale data.

In addition, high-speed storage devices (SSDs) and high-capacity storage devices (HDDs) may be appropriately utilized to optimize data storage and access speeds.

The search image retrieval unit 230 may be configured to derive search metadata of search footage within a preset search range from the metadata based on the request information, request the search footage corresponding to the search metadata from the provider terminal 100, and receive the search footage from the provider terminal 100.

That is, the search image retrieval unit 230 may filter footage filmed within a certain distance radius from the desired location or within a certain time range from the desired time based on the metadata, request such footage from the provider terminal, and receive it, thereby performing a first-stage filtering. This may narrow the search range and reduces search or retrieval time.

In addition, while the location of the footage desired by the consumer may be set based on general location information such as an address, it is preferable to link with a map system such as GIS so that the consumer can define the search range in a more segmented manner based on detailed location information input for a specific area.

As such, the search image retrieval unit 230 may be configured to first define a search range based on the request information (i.e., time, location, and region of interest) input by the consumer, search the metadata stored in the database 220, and receive the corresponding search footage from the provider terminal.

In addition, the search image retrieval unit 230 may be configured to allow the consumer to conveniently search based on location by linking with a geographic information system (GIS), enabling the consumer to input a location on a map. The search image retrieval unit 230 may then filter the search footage by setting a predefined radius around the specified point on the GIS map and narrowing the search range by filtering footage captured within the requested time or time range.

As shown in FIG. 1, the similar image derivation unit 240 may be configured to derive footage with a similarity equal to or higher than a preset similarity threshold by comparing the derived search footage with the spot image included in the request information using an artificial intelligence-based image similarity model.

Here, the similarity detection technology using the artificial intelligence-based image similarity model employs a convolutional neural network (CNN) to extract visual features from images, vectorizes these features, and calculates the similarity between two images. The process may proceed as follows:
1) Feature Extraction: A convolutional neural network (CNN) is used to extract visual features from the input image. The CNN extracts features at various levels such as edges, textures, and patterns.
2) Feature Maps: The extracted features are represented as feature maps across multiple layers of the CNN. These feature maps contain important visual information of the image.
3) Feature Vector Generation: The feature maps from the final layers of the CNN are flattened into a single vector. This vector represents the unique visual characteristics of the image. The flattened vector corresponds to a point in a high-dimensional space and is used to compare similarities between images.
4) Similarity Calculation-Cosine Similarity: Cosine similarity is commonly used to measure the similarity between two vectors by calculating the angle between them. A smaller angle indicates higher similarity.
5) Euclidean Distance: Alternatively, Euclidean distance can be used to calculate the distance between two vectors, where a shorter distance implies higher similarity.
6) Similar Image Derivation: Images that exceed a preset similarity threshold (e.g., a cosine similarity threshold) may be selected as similar images.
7) Ranking Based on Similarity Scores: The images may be ranked based on similarity scores, and the most similar images can be derived in descending order of similarity.

That is, the similar image derivation unit 240 may be a module configured to calculate the similarity or matching degree between dashcam footage captured in a certain direction (e.g., the traveling direction of a mobility device such as a vehicle or motorcycle equipped with a dashcam or the viewing angle of the footage) and a spot image (which may include a road view) directly input by the user as an example of the desired footage. This comparison is performed using a convolutional neural network (CNN) or the like, and when the calculated similarity exceeds a preset similarity threshold, the footage may be determined to match.

In addition, the similar image derivation unit may also provide not only the similar footage itself but also accompanying data such as the direction and speed of the footage, as well as the size and clarity of detected objects. Such supplementary information can significantly assist the consumer in making a subsequent purchase decision regarding the similar dashcam footage.

The similar image derivation unit 240 employs computer vision technologies for image analysis and similarity evaluation. In particular, deep learning models such as Convolutional Neural Networks (CNNs) may be utilized to analyze similarity by extracting and comparing features from images.

Generally, dashcam footage recorded by a vehicle can vary significantly in terms of event recognition accuracy, even when covering the same area, depending on the position of the vehicle and the angle (field of view) of the recording camera. Accordingly, identifying the exact footage desired by the user is extremely difficult and time-consuming.

To address this issue, the video provision system according to an exemplary embodiment of the present disclosure allows a user to input a spot image (including road view images) that reflects the desired location and shooting direction of the footage as part of the request information. The system, through the similar image derivation unit 240, evaluates the similarity between the input spot image and numerous dashcam footages preliminarily retrieved based on metadata. Only those footages having a similarity equal to or exceeding a preset threshold are selected and provided to the user.

As illustrated in FIG. 1, a de-identification processing unit 250 may be configured to detect personally identifiable objects in the similar footage derived by the similar image derivation unit 240 and perform de-identification processing on the detected objects.

The de-identification processing unit 250 may include: an object detection module 251 for detecting personally identifiable objects in the similar footage using an artificial intelligence-based object detection model in accordance with the request information: a de-identification processing module 253 for performing de-identification processing, such as mosaic or blur, on the detected personally identifiable objects; and a de-identification level setting module 255 for adjusting the level of de-identification processing based on a request from a provider or administrator.

Here, the object detection module may use an object detection model such as YOLO (You Only Look Once) to identify specific objects (e.g., human faces) in the video. To enhance detection accuracy, the model may be trained and optimized using dashcam footage data.

The de-identification processing module 253 may apply a mosaic algorithm to the identified objects, and the de-identification level setting module 255 may be configured to set or adjust the de-identification level by controlling the size and intensity of mosaic blocks.

In addition, the mosaic processing algorithm may be selectively applied to the detected objects based on requirements, thereby performing effective de-identification.

The video provision unit 260 may be configured to transmit the de-identified similar footage to the consumer terminal 300.

In addition, the video provision unit 260 may include: a transaction settlement unit 261 configured to process payment and settlement when the consumer terminal 300 confirms a portion of the de-identified similar footage processed by the de-identification processing unit 250 and decides to purchase the similar footage; and a video transmission unit 263 configured to transmit the de-identified similar footage to the consumer terminal 300 upon completion of the transaction settlement by the transaction settlement unit 261.

In addition, the video provision unit 260 is configured to transmit the de-identified similar footage to the consumer terminal 300, and may also back up the de-identified footage and encrypt it prior to transmission to enhance security.

Here, the transaction settlement unit 261 may be configured to handle the payment and settlement process when the consumer confirms a portion of a specific video and decides to purchase it.

The transaction settlement unit 261 may also include a mechanism that utilizes an algorithm to match data providers and consumers based on predefined criteria such as data type, quality, and application domain, thereby simplifying the transaction process and providing an efficient and user-friendly black box (dashcam) footage trading service.

Further, the transaction settlement unit 261 may include a payment and settlement module (not shown) for facilitating financial transactions related to the purchase and sale of black box (dashcam) footage. The payment and settlement module may form virtual accounts for registered data providers and consumers, enabling them to review transaction histories related to the trading of black box (dashcam) footage, and may support various payment methods to offer flexibility and convenience to users.

The video transmission unit 263 may be configured to transmit the de-identified footage to the consumer terminal 300 upon completion of the transaction settlement.

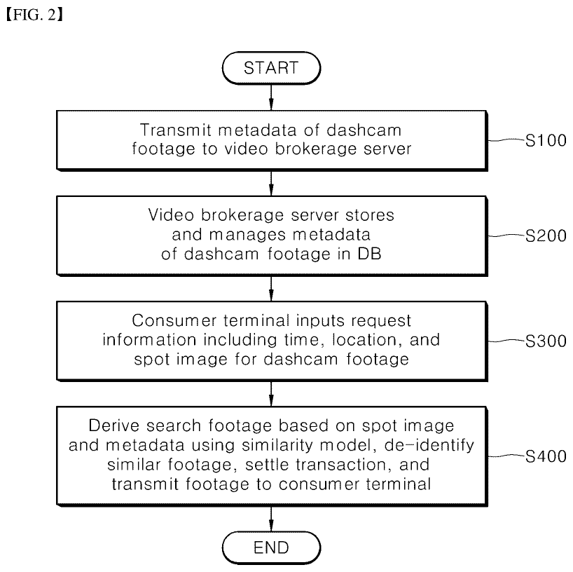

FIG. 2 is a flowchart illustrating a method for providing dashcam footage according to an exemplary embodiment of the present disclosure.

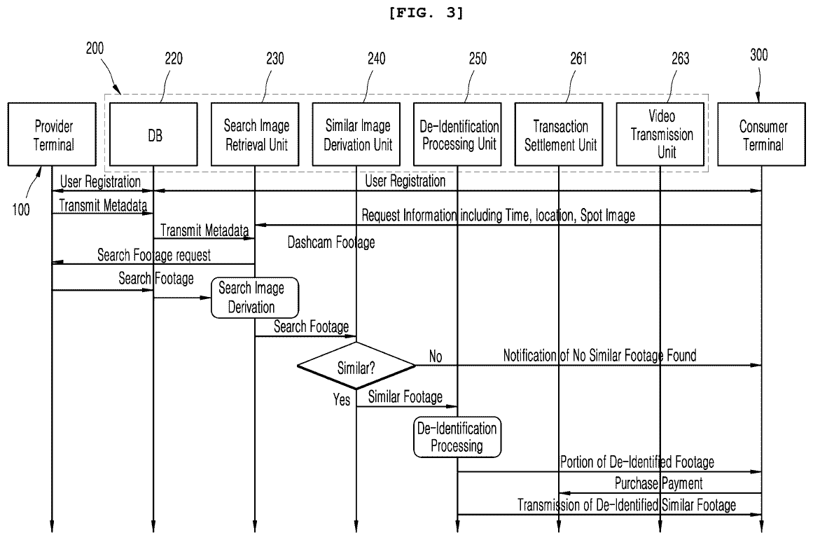

In addition, FIG. 3 is a diagram illustrating a detailed process of providing footage using the system for providing dashcam footage according to an embodiment of the present disclosure.

As shown in FIG. 2, the method for providing dashcam footage according to an exemplary embodiment of the present disclosure may comprise: (a) a step S100 of transmitting metadata: (b) a step S200 of storing and managing the metadata: (c) a step S300 of requesting dashcam footage; and (d) a step S400 of providing de-identified similar dashcam footage.

Here, the step (a) (S100) may be a step in which the provider terminal 100 collects metadata of dashcam footage and transmits the collected metadata to the video brokerage server.

The step (b) (S200) may be a step in which the video brokerage server 200 receives the metadata from the provider terminal 100, stores the metadata, and manages the metadata.

The step (c) (S300) may be a step in which the consumer terminal 300 accesses the video brokerage server 200 and requests dashcam footage by inputting request information including time, location, and a spot image of a region of interest.

In particular, the step (c) (S300) may comprise: (c1) a step in which the user registration unit 210 accesses the video brokerage server 200 and performs user registration; and (c2) a step in which the video request unit requests dashcam footage based on request information input by the consumer, the request information including the time, location, and a region-of-interest image of the dashcam footage.

In addition, the step (d) (S400) may be a step in which the video brokerage server 200 derives search metadata of search footage within a preset search range from the metadata based on the request information, receives the search footage corresponding to the derived search metadata from the provider terminal 100, derives similar footage using the spot image and an artificial intelligence-based image similarity model, performs de-identification processing, and transmits the de-identified similar footage to the consumer terminal for provision.

In addition, the step (d) (S400) may comprise: (d1) a step of deriving search metadata: (d2) a step of receiving search footage: (d3) a step of deriving similar footage: (d4) a step of performing de-identification processing: (d5) a step of performing transaction settlement; and (d6) a step of transmitting the similar footage.

Here, the step (d1) may be a step in which the search image retrieval unit 230 derives search metadata of search footage within a preset search range from the metadata based on the request information.

In addition, the step (d2) may be a step in which the search image retrieval unit 230 transmits the derived search metadata to the corresponding provider terminal and receives the search footage corresponding to the search metadata.

The step (d3) may be a step in which the similar image derivation unit 240 derives similar footage having a similarity equal to or higher than a preset threshold by comparing the received search footage with the spot image included in the request information using an artificial intelligence-based image similarity model.

The step (d4) may be a step in which the de-identification processing unit 250 detects personally identifiable objects in the similar footage using an artificial intelligence-based object detection model and performs de-identification processing on the detected objects.

The step (d5) may be a step in which, when the consumer terminal 300 confirms a portion of the de-identified similar footage processed by the de-identification processing unit 250 and decides to purchase the similar footage, the transaction settlement unit 261 processes payment and settlement for the purchase.

The step (d6) may be a step in which, when the transaction settlement by the transaction settlement unit 261 is completed, the transmission unit transmits the de-identified similar footage to the consumer terminal 300.

The video provision process through the signal flow between components of the dashcam (black box) footage provision system will now be described with reference to FIG. 3 as follows.

As shown in FIG. 3, a provider terminal 100 that collects and provides dashcam footage, and a consumer who needs specific dashcam footage may access the video brokerage server 200 through a consumer terminal 300 and register as a user by entering an ID, password, and user information.

Information of the user (e.g., provider, consumer) entered during the user registration process may be stored and managed in the database (DB) 220.

Multiple provider terminals 100 transmit metadata of dashcam footages captured in various regions and during time periods to the video brokerage server 200. The transmitted metadata is then stored in the DB 220 of the video brokerage server 200.s

Here, the metadata of the dashcam footage may be transmitted in real time to the DB of the video brokerage server 200. In addition, the metadata may be collected and stored periodically or non-periodically as needed.

When one of the consumer terminals 300 attempts to search for footage related to a particular incident that has occurred, the consumer may access the video brokerage server 200 and enter request information including the time, location, and a spot image that clearly reflects the context of the incident. The entered request information is handled by the search image retrieval unit 230, which derives search footage based on a predefined search range using metadata such as time and location.

Here, the spot image may be at least one image that the consumer has directly captured in the desired field of view of the target area. Such spot footage not only clearly represents the characteristics of the desired footage, but also defines the target footage for retrieval. Given the unstructured nature of dashcam footage, a spot image serves as high-quality input data that allows for fast and accurate retrieval of similar footage.

The derived search footage is delivered to the similar image derivation unit 240, which calculates the similarity between the search footage and the spot image included in the request information using an artificial intelligence (AI) based similarity detection algorithm.

When the similarity score calculated by the AI algorithm in the similar image derivation unit 240 is equal to or exceeds a predefined threshold, the corresponding footage is determined to be similar footage and is delivered to the de-identification processing unit 250.

When the similarity score is below the threshold, the consumer terminal 300 may be notified that no similar footage is available.

In addition, the similarity evaluation by the similar image derivation unit 240 may include a technique that extracts a matching scene by comparing the search footage (derived based on movement direction and route data) to a spot image such as a road view image or an image uploaded by the user.

The de-identification processing unit 250 receives the similar footage, detects objects to be de-identified through the object detection module, applies mosaic processing to the detected objects via the de-identification processing module 253, and transmits a portion of the de-identified similar footage to the consumer terminal 300.

When the consumer, upon reviewing the partially de-identified footage on the consumer terminal 300, determines that the footage is related to the sought event, the purchase amount for the similar footage may be settled through the payment module of the transaction settlement unit 261.

Once settlement is confirmed, the fully de-identified similar footage may be transmitted from the de-identification processing unit 250 to the consumer terminal 300, thereby completing the dashcam footage provision process.

Here, the de-identification processing unit 250 may also transmit the de-identified similar footage to the DB 220, which in turn may provide the footage to the consumer terminal 300.

In addition, another exemplary embodiment of the present disclosure may include a computer program stored on a non-transitory medium for executing the method for providing dashcam footage.

Further, the program applicable to the method for providing dashcam footage according to an exemplary embodiment of the present disclosure may be implemented as computer-readable code on a computer-readable recording medium. The code and code segments implementing the above programs can be readily deduced by a computer programmer of ordinary skill in the art.

Here, a computer-readable recording medium may include any kind of recording device that stores data that can be read by a computer system. Examples of computer-readable recording media may include ROM, RAM, CD-ROM, magnetic tape, floppy disk, optical disk, and the like. Further, the computer-readable recording medium may be distributed across a networked computer system and may be written and executed as computer-readable code in a distributed manner.

As described above, the dashcam footage provision system and method according to an exemplary embodiment of the present disclosure provide the following effects and advantages:

### 1) Efficient Dashcam Footage Search and Provision

The present disclosure enables rapid search of footage corresponding to a user-requested time, location, and area of interest by utilizing Geographic Information Systems (GIS) and computer vision technology, allowing consumers to efficiently and quickly locate the required footage.

Furthermore, if the information user (consumer) is unable to resolve an incident or accident using their own data, the system allows resolution through transactions with other information providers, creating an ecosystem for the maximum utilization of dashcam footage.

In addition, the exemplary embodiment of the present disclosure uses deep learning models such as Convolutional Neural Networks (CNN) to accurately derive footage similar to the requested spot footage, which is highly effective in retrieving videos with a specific and desired viewing angle.

### 2) Privacy Protection

By applying deep learning-based object detection models along with mosaic and blur processing techniques, the present disclosure effectively de-identifies personal information (e.g., faces, vehicle license plates) contained in the footage, thereby ensuring privacy while enhancing footage utility.

Moreover, the inclusion of a module that allows adjustment of the level of de-identification provides flexibility to meet various requirements.

Using the system, information users may request investigations by law enforcement with the de-identified video, and the police may obtain the original footage via the video brokerage server (platform), contributing to the resolution of incidents while maintaining privacy protections.

### 3) Data Security

The present disclosure enhances data security by encrypting de-identified footage before transmission, and prevents data loss by securely storing the data via a backup module. By applying blockchain technology that assigns channel IDs among public networks and nearby devices, the system enables tamper-proof footage management.

As the system handles sensitive information, encryption and backup mechanisms ensure data integrity and security.

### 4) User Convenience

The system offers an intuitive interface on the consumer terminal 300 for easy input of request information and reception of de-identified footage, thereby improving user experience and accessibility.

### 5) Economic Benefit

By enabling consumers to purchase and settle payments for desired footage, the system offers additional revenue opportunities for providers and enhances the economic value of dashcam footage.

In addition, consumers are allowed to preview parts of the footage before purchasing, enabling them to evaluate the quality and relevance of the footage beforehand.

### 6) Diversity and Scalability

The present disclosure allows footage to be collected and provided through various devices such as navigation terminals, in-vehicle terminals, and mobile devices, offering flexibility and scalability. The system and method of the present disclosure may also be applied across multiple fields, including traffic accident analysis, road condition monitoring, insurance claim processing, and urban planning.

### 7) Reliability and Stabilitys

The system ensures reliability and stability through a DBMS that efficiently manages large-scale data and high-speed storage devices. The system and method of the present disclosure also allow real-time collection, storage, and provision of dashcam footage, providing a system and method capable of rapid response based on up-to-date information.

In the above, although several preferred embodiments of the present disclosure have been described with some examples, the descriptions of various exemplary embodiments described in the “Specific Content for Carrying Out the Invention” item are merely exemplary, and it will be appreciated by those skilled in the art that the present disclosure can be variously modified and carried out or equivalent executions to the present disclosure can be performed from the above description.

In addition, since the present disclosure can be implemented in various other forms, the present disclosure is not limited by the above description, and the above description is for the purpose of completing the disclosure of the present disclosure, and the above description is just provided to completely inform those skilled in the art of the scope of the present disclosure, and it should be known that the present disclosure is only defined by each of the claims.

### LIST OF REFERENCE NUMBERS

100: provider terminal
200: video brokerage server
210: user registration unit
220: database (DB)
230: search image retrieval unit
240: similar image derivation unit
250: de-identification processing unit
251: object detection module
253: de-identification processing module
255: de-identification level setting module
260: video provision unit
261: transaction settlement unit
263: video transmission unit
300: consumer terminal

What is claimed is:

1. A system for providing dashcam footage comprising a provider terminal, a consumer terminal, and a video brokerage server,
wherein the provider terminal is configured to transmit at least one of metadata of dashcam footage or the dashcam footage to a video brokerage server;
wherein the consumer terminal is configured to access the video brokerage server and input request information for desired dashcam footage, the request information including time, location, and a spot image of a region of interest; and
wherein the video brokerage server is configured to:
derive, from the metadata, search metadata of search footage within a preset search range based on the request information;
receive the search footage corresponding to the derived search metadata from the provider terminal;
derive similar footage using an artificial intelligence-based image similarity model based on the spot image;
perform de-identification processing on the similar footage; and
transmit the de-identified similar footage to the consumer terminal, for providing the de-identified similar footage.

2. The system of claim 1,
wherein the provider terminal is a terminal device connected via wired or wireless communication to a dashcam device mounted on a mobility and configured to receive the dashcam footage,
the terminal device being at least one selected from the group consisting of a navigation terminal, a vehicle terminal, and a mobile device.

3. The system of claim 1,
wherein the consumer terminal comprises:
a registration unit configured to access the video brokerage server and perform user registration;
a video request unit configured to input request information including time, location, and a spot image of a region of interest to request desired dashcam footage; and
an output unit configured to receive the de-identified similar footage from the video brokerage server and output the de-identified similar footage.

4. The system of claim 1,
wherein the video brokerage server comprises:
a database configured to store and manage the dashcam footage received from the provider terminal;
a search image retrieval unit configured to derive search metadata of search footage within a preset search range from the metadata based on the request information, request the search footage corresponding to the derived search metadata from the provider terminal, and receive the search footage from the provider terminal;
a similar image derivation unit configured to derive footage having a similarity equal to or higher than a preset threshold by comparing the derived search footage with the spot image included in the request information using the artificial intelligence-based image similarity model;
a de-identification processing unit configured to detect a personally identifiable object in the similar footage derived by the similar image derivation unit and perform de-identification processing on the detected personally identifiable object; and
a video provision unit configured to transmit the de-identified similar footage to the consumer terminal.

5. The system of claim 1,
wherein the de-identification processing unit comprises:
an object detection module configured to detect and identify a personally identifiable object in the similar footage using an object detection artificial intelligence model based on the request information;
a de-identification processing module configured to perform de-identification processing on the detected personally identifiable object, the de-identification processing including at least one selected from the group consisting of mosaic processing and blur processing; and
a de-identification level setting module configured to reset a level of de-identification processing based on a request from a provider or administrator.

6. The system of claim 4,
wherein the video provision unit comprises:
a transaction settlement unit configured to process transaction settlement when the consumer terminal confirms a portion of the de-identified similar footage processed by the de-identification processing unit and decides to purchase the de-identified similar footage; and
a video transmission unit configured to transmit the de-identified similar footage to the consumer terminal when the transaction settlement by the transaction settlement unit is completed.

7. A method for providing dashcam footage, comprising the steps of:
(a) collecting, by a provider terminal, metadata of dashcam footage and transmitting the collected metadata to a video brokerage server;
(b) receiving and storing, by the video brokerage server, the metadata from the provider terminal for management;
(c) requesting, by a consumer terminal, dashcam footage by accessing the video brokerage server and inputting request information including time, location, and a spot image of a region of interest; and
(d) deriving, by the video brokerage server, search metadata of search footage within a preset search range from the metadata based on the request information; receiving the search footage corresponding to the derived search metadata from the provider terminal; deriving similar footage using an artificial intelligence-based image similarity model based on the spot image; performing de-identification processing on the similar footage; and transmitting the de-identified similar footage to the consumer terminal.

8. The method of claim 7,
wherein the step (c) comprises:
(c1) accessing, by a registration unit, the video brokerage server and performing user registration; and
(c2) requesting, by a video request unit, dashcam footage through request information input by a consumer, the request information including time, location, and a spot image of a region of interest of the dashcam footage.

9. The method of claim 7,
wherein the step (d) comprises:
(d1) deriving, by a search image retrieval unit, search metadata of search footage within a preset search range from the metadata based on the request information;
(d2) transmitting, by the search image retrieval unit, the derived search metadata to the provider terminal and receiving the search footage corresponding to the derived search metadata from the provider terminal;
(d3) deriving, by a similar image derivation unit, similar footage having a similarity equal to or higher than a preset threshold by comparing the received search footage with the spot image included in the request information using the artificial intelligence-based image similarity model;
(d4) detecting, by a de-identification processing unit, a personally identifiable object in the similar footage using an artificial intelligence-based object detection model, and performing de-identification processing on the detected personally identifiable object;
(d5) processing, by a transaction settlement unit, transaction settlement when the consumer terminal confirms a portion of the de-identified similar footage processed by the de-identification processing unit and decides to purchase the similar footage; and
(d6) transmitting, by a transmission unit, the de-identified similar footage to the consumer terminal when the transaction settlement by the transaction settlement unit is completed.

10. A computer program stored on a medium for executing the method of claim 8.
